(19) United States
(12) Patent Application Publication
(10) Pub. No.: US 2002/0113774 A1
(43) Pub. Date: Aug. 22, 2002

(54) Notebook computer having a separable cursor controller

(76) Inventor: Su-Yun Chen, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/824,094

(22) Filed: Apr. 3, 2001

(30) Foreign Application Priority Data
Feb. 16, 2001 (TW) 90103612

(51) Int. Cl. G09G 5/08

(52) U.S. Cl. 345/157

(57) ABSTRACT

The present invention proposes a notebook computer having a separable cursor controller, which can control the cursor of the notebook computer in wireless communication way or in wired connection way. The cursor controller comprises a switching device, a wireless pointer, and a wired pointer. The operation of the cursor controller can be accomplished by connecting to a receiving space of a shell body of the notebook computer to achieve electric connection so as to enable the operation of the wired pointer. At the same time, the switching device is used to disable the wireless pointer. Contrarily, the cursor controller can be separated from the notebook computer, and the switching device is used to enable the operation of the wireless pointer.

### FIELD OF THE INVENTION

The present invention relates to a notebook computer having a separable cursor controller, which can selectively control the cursor of the notebook computer either using a wired pointer when connected with the notebook computer or using a wireless pointer when separated from the notebook computer.

### BACKGROUND OF THE INVENTION

FIG. 1A shows a prior art connection way of a personal computer 1 and a mouse device 10. FIG. 1B shows a function block diagram of the mouse device 10 and the personal computer 1. The mouse device 10 comprises a key unit, a displacement detecting unit 101, and an interface circuit 102. The mouse device 10 is connected to the personal computer 1 via an electric cable. The displacement detecting unit 101 is used to detect the displacement of the mouse device 10. The displacement signal is encoded and transformed by the interface circuit 102 and then transferred to a mouse input circuit 11 of the personal computer 1 via the electric cable, thereby controlling the position of the cursor on the screen. In the prior art, the displacement detecting unit 101 can be either mechanical type or optoelectric type, wherein the detection of the former is accomplished by driving rollers for controlling the directions of two coordinates to move with rolling balls and then generating the displacement signal, while the detection of the latter is accomplished by detecting the displacement of the mouse device 10 with a laser light and then generating the displacement signal. Furthermore, in addition to using a wired cable for connection, the mouse device 10 can also transfer signals to the personal computer 1 in wireless way.

FIG. 2A shows a perspective view of a prior art notebook computer having a handwriting or touch pad 20. FIG. 2B shows a function block diagram of the touch pad 20 and the notebook computer 2. The touch pad 20 comprises a displacement detecting unit 201 and an interface circuit 202. The displacement detecting unit 201 is touched by the fingers of a user for detecting the displacement of the fingers, and the displacement signal is then transferred to the notebook computer 2, thereby controlling the position of the cursor on the screen.

However, although the notebook computer 2 has the touch pad 20 capable of controlling the position of the cursor, the user tends to be more familiar with the operation of the handheld mouse device 10. Therefore, the user usually brings an additional mouth device 10 to connect the notebook computer for operation, resulting in decrease of usage of the handwriting or touch pad 20.

### SUMMARY OF THE INVENTION

The primary object of the present invention is to provide a notebook computer having a separable cursor controller. The present invention comprises mainly a shell body of notebook computer and a separable cursor controller. The cursor controller can control the position of the cursor of the notebook computer in wired connection way or in wireless communication way. The cursor controller comprises mainly a wireless pointer, a wired pointer, a switching device, and a rechargeable battery. The operation of the cursor controller can be accomplished by connecting to a receiving space of the shell body to achieve electric connection so as to enable the operation of the wired pointer. At the same time, the switching device is used to disable the wireless pointer, and the external power supply of the notebook computer is used to charge the rechargeable battery. Or the cursor controller can be separated from the notebook computer, and the switching device is used to enable the operation of the wireless pointer. Meanwhile, the rechargeable battery is used to supply electricity for the wireless pointer. Thereby, the primary object of the present invention can be achieved.

Another object of the present invention is to provide a handheld cursor controller combining an optoelectric pointer and a pointer of a handwriting or touch pad. The handheld cursor controller can be joined with a notebook computer or be separated from it for use, thereby solving the drawback and inconvenience of bringing another handheld mouse.

The present invention can effectively enhance the efficiency of use of the cursor controller of a notebook computer so as to enhance the sale of notebook computers and to increase the convenience of operation of notebook computers.

The various objects and advantages of the present invention will be more readily understood from the following detailed description when read in conjunction with the appended drawing, in which:

### BRIEF DESCRIPTION OF THE DRAWINGS

FIG. 1A is a diagram showing the connection between a personal computer and a mouse device in the prior art;

FIG. 1B is a function block diagram of FIG. 1A;

FIG. 2A is a perspective view of a notebook computer having a handwriting or touch pad of the prior art;

FIG. 2B is a function block diagram of FIG. 2A;

FIG. 3 is a top view of the present invention embodied in wireless way;

FIG. 4 is a top view of the present invention embodied in wired way;

FIG. 5 is a function block diagram of a notebook computer having a separable cursor controller according to the present invention;

FIG. 6 is a function block diagram of the wireless pointer in FIG. 5 according to an embodiment of the present invention; and

FIG. 7 is a function block diagram of the wired pointer in FIG. 5 according to an embodiment of the present invention.

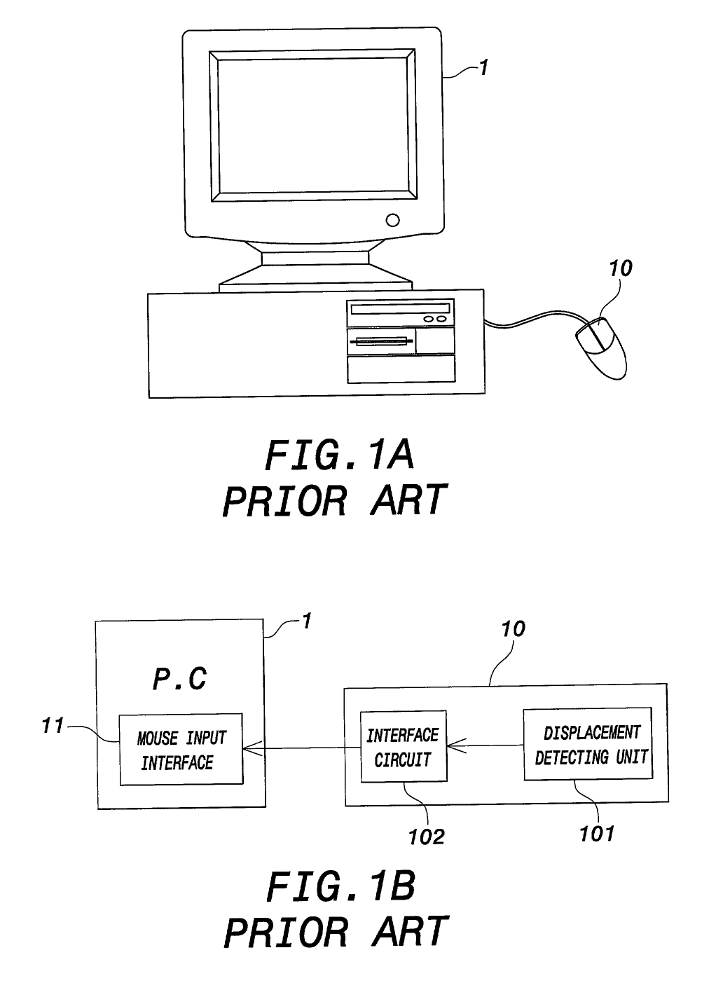

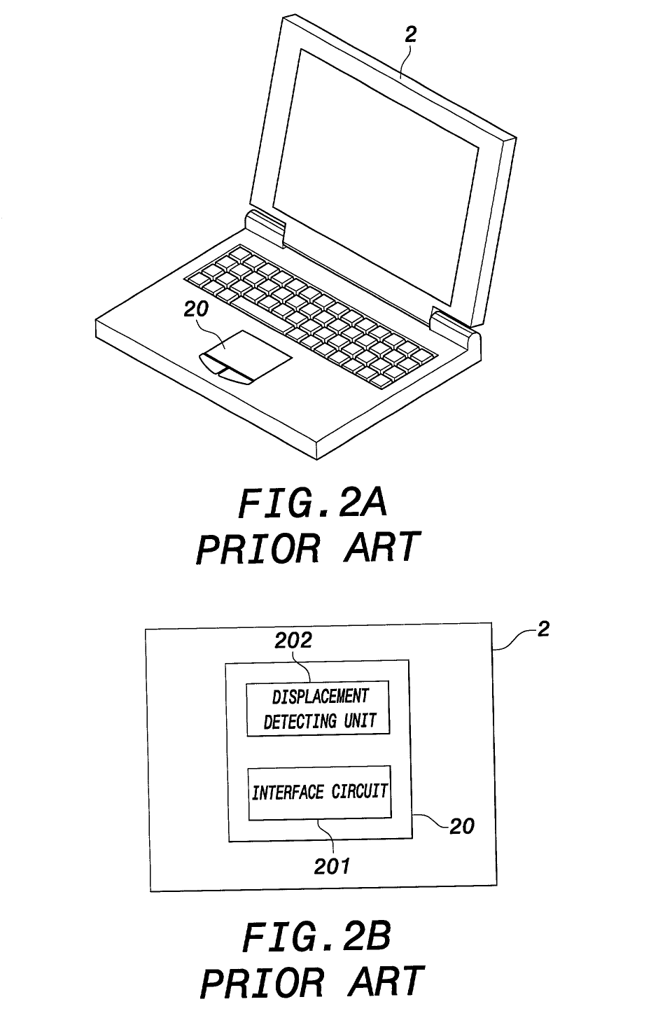

### DETAILED DESCRIPTION OF THE PREFERRED EMBODIMENTS

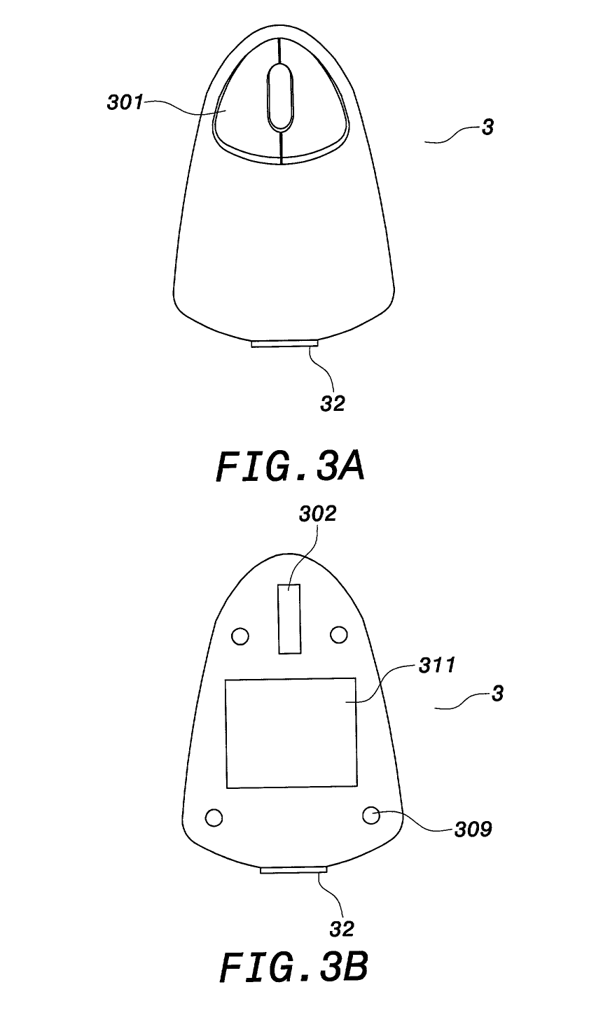

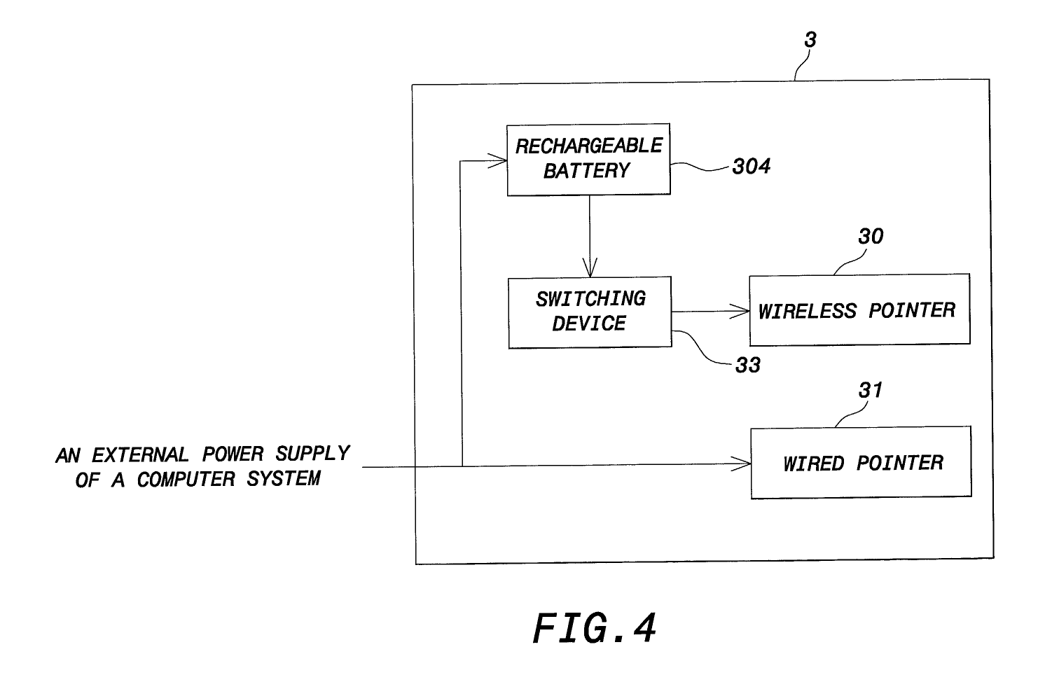

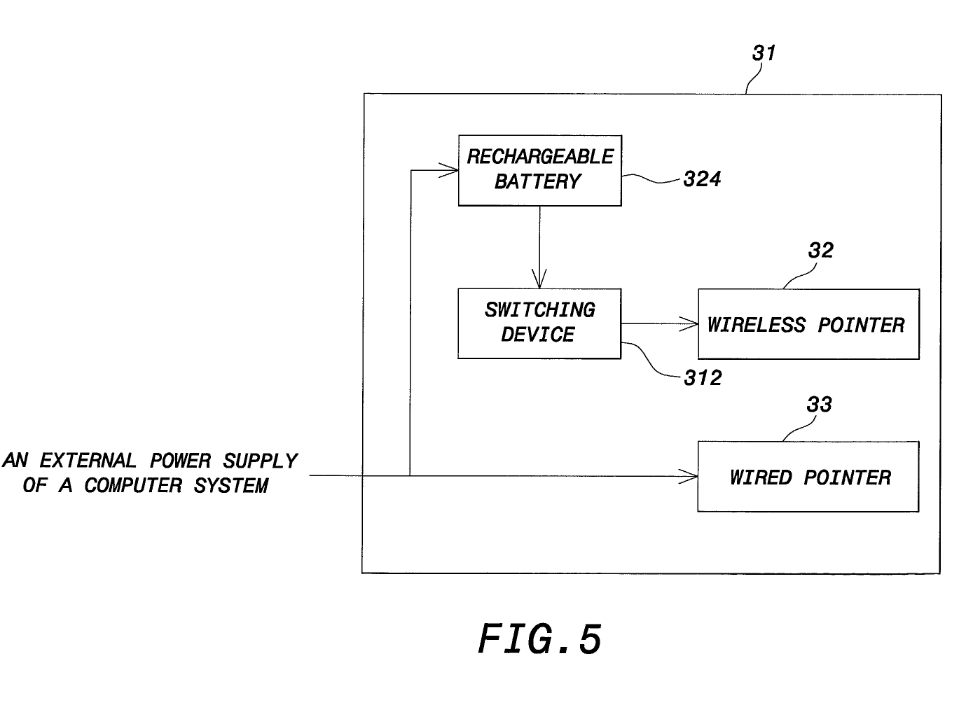

As shown in FIGS. 3 and 4, a notebook computer 3 having a separable cursor controller according to the present invention comprises mainly a shell body 30 and a cursor controller 31. The cursor controller 31 has a wireless pointer 32 and a wired pointer 33 (shown in FIG. 5). The cursor controller 31 can be joined with the shell body 30 to enable the operation of the wired pointer 33 for controlling the position of the cursor of the notebook computer 3. The cursor controller 31 can also be separated from the shell body 30 to enable the operation of the wireless pointer 32 for controlling the position of the cursor of the notebook computer 3.

As shown in FIGS. 3 and 4, the notebook computer 3 having a separable cursor controller has an electric contact 311 disposed at a predetermined position of the cursor controller 31. The predetermined position is matched so that a mating connector 302 is disposed at a corresponding position to achieve electric connection between the cursor controller 31 and the notebook computer 3 so as to enable the operation of the wired pointer 33 when the cursor controller 31 is joined with a receiving space 301 on the shell body 30. Additionally, the cursor controller 31 also has a switching device 312 (shown in FIG. 5).

When the cursor controller 31 is joined with the receiving space 301 on the notebook computer 3, the switching device 312 will disable the function of the wireless pointer 32. When the cursor controller 31 is separated from the receiving space 301 on the notebook computer 3, the switching device 312 will enable the operation of the wireless pointer 32 to control the position of the cursor of the notebook computer 3 in wireless communication way. In a preferred embodiment of the present invention, the switching device 312 of the cursor controller 31 is a micro-switch, and the receiving space 301 of the notebook computer 3 has a pin or lock mechanism so that the pin or lock mechanism can activate the micro-switch when the cursor controller 31 is placed into the receiving space, hence cutting off electricity supply for the wireless pointer 32 to let it lose its function. When operated contrarily, the micro-switch will connect a power supply to the wireless pointer 32 to let it restore its function.

As shown in FIG. 5, the cursor controller 31 comprises a rechargeable battery 324 connected to the electric contact 311. When the cursor controller 31 is joined with the receiving space 301, it can join the connector 302 of the shell body 30 through the electric contact 311 to acquire external electricity, thereby enabling the operation of the wired pointer 33 and simultaneously charging the rechargeable battery 324. At the same time, the switching device 312 cuts off the electric path of the rechargeable battery 324 to the wireless pointer 32. The switching device 312 does not connect the rechargeable battery 324 with the wireless pointer 32 until the cursor controller 31 is separated from the receiving space 301. The wireless pointer 32 and the wired pointer 33 of the cursor controller 31 of the notebook computer 3 having a separable cursor controller according to the present invention will be further illustrated below.

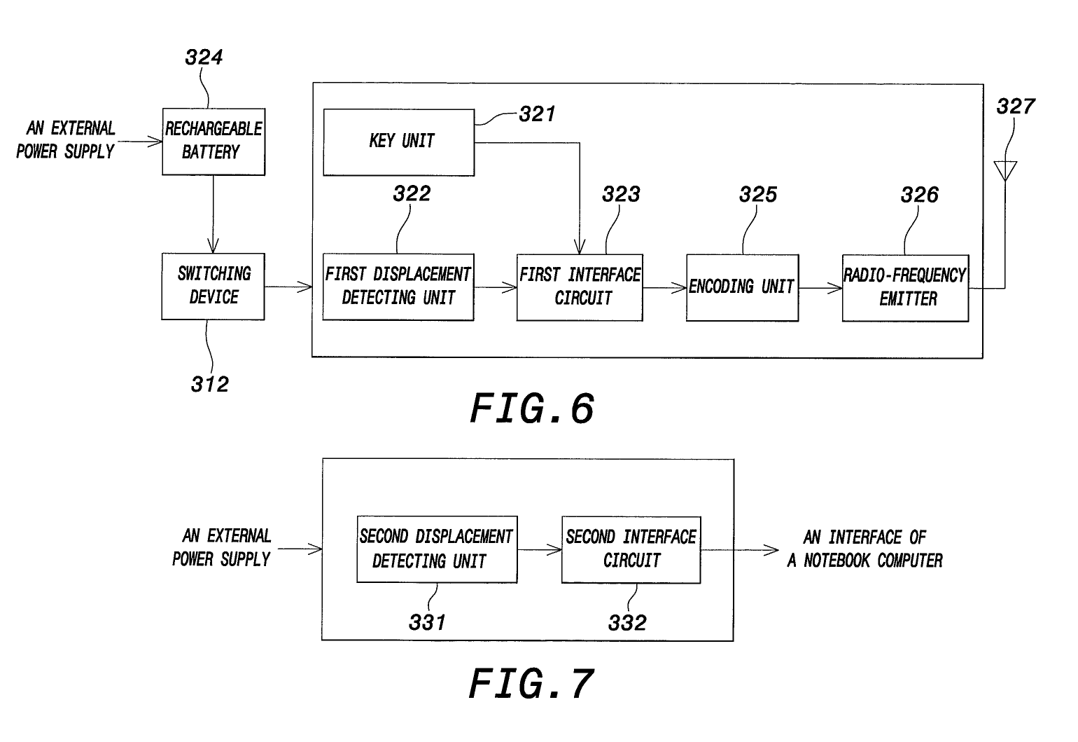

As shown in FIG. 6, when the cursor controller 31 is separated from the receiving space 301 of the notebook computer 3, the electric contact 311 cuts off the external power supply to stop the charging of the rechargeable battery 324 and to disable the wired pointer 33. The switching device 312 will conduct the electric path between the rechargeable battery 324 and the wireless pointer 32 to enable the operation of the wireless pointer 32. The wireless pointer 32 comprises a key unit 321, a first displacement detecting unit 322, a first interface circuit 323, an encoding unit 325, a radio-frequency (RF) emitter 326, and an antenna 327. When the cursor controller 31 is individually operated, the first displacement detecting unit 322 will detect the displacement of the cursor controller 31 and then generate a displacement signal. The first interface circuit 323 receives the displacement signal and detects a keystroke signal of the key unit 321 and then transforms them into electric signals, which are encoded by the encoding unit 325 and then emitted out by the RF emitter 326. In this way, the displacement signal and the keystroke signal are transferred to the notebook computer 3.

In a preferred embodiment of the present invention, the wireless pointer 32 lets the cursor controller 31 be an optoelectric wireless mouse device, and lets the first displacement detecting unit 322 be an optoelectric displacement detecting unit. A detecting window at the bottom of the cursor controller 31 is used to detect the movement of the cursor controller 31 on a plane by reflection of laser light.

As shown in FIG. 7, when the cursor controller 31 is joined with the receiving space 301 of the notebook computer 3, the cursor controller 31 can acquire external electricity through the electric contact 311 to enable the wired pointer 33. At the same time, the switching device 312 will cut off the electric path of the rechargeable battery 324 to the wireless pointer 32. The wired pointer 33 comprises a second displacement detecting unit 331 and a second interface circuit 332. A user can operate the second displacement detecting unit 331 to generate a displacement signal, which is transformed by the second interface circuit 332 and then transferred to the notebook computer 3 via the electric contact 311.

In a preferred embodiment of the present invention, the wired pointer 33 lets the cursor controller 31 be a fixed handwriting or touch pad when joined with the notebook computer 3, and lets the second displacement detecting unit 331 be a displacement detecting unit of the handwriting or touch pad. When the cursor controller 31 is joined with the shell body 30, the displacement detecting unit of the handwriting or touch pad is disposed at the bottom of the cursor controller 31 and the bottom thereof is installed upwards so that one's fingers can directly operate on the handwriting or touch pad in the same way as the operation of a general notebook computer.

Additionally, a spacer 328 can be attached on the bottom face of the cursor controller 31 so that the detecting window at the bottom thereof and the displacement detecting unit of the handwriting or touch pad can be prevented from directly contacting the plane when the cursor controller 31 is used as a wireless mouse device.

Furthermore, the receiving space 301 of the shell body 30 of the notebook computer 3 having a separable cursor controller according to the present invention has a mobile plate, which together with a resilient part forms a jointly moving mechanism. When the cursor controller 31 is placed into the receiving space 301, the mobile plate is pushed to activate the resilient part so as to let the receiving space 301 form a room for exactly receiving the cursor controller 31. When the cursor controller 31 is taken out, the restoring force of the resilient part is exploited to activate and restore the mobile plate so as to form a smooth structure with the shell body 30. Apparently, a mobile cover plate can also be adopted in the present invention. When the cursor controller 31 is separated from the receiving space 301, through the joining of a slide track, a pin, or a retaining tenon of the cover plate with the shell body 30, the shell body will form a smooth structure at the receiving space 301.

The present invention provides a notebook computer having a separable cursor controller. The displacement signals of the cursor controller can be transferred to the notebook computer via an electric cable in wired connection way. Or the displacement signals of the cursor controller can be transferred to the notebook computer in wireless communication way when the cursor controller is separated from the shell body of notebook computer, thereby providing the effect of separate operation for the fixed handwriting or touch pad of a prior art notebook computer and increasing convenience of operation of the cursor controller of a notebook computer.

Additionally, the present invention provides an optoelectric pointer combined with a separable handheld cursor controller of a handwriting or touch pad for a notebook computer, thus solving the drawback and inconvenience of bringing another handheld mouse.

Another function of the present invention is to provide an electric connection way of a wireless pointer with the shell body of a notebook computer so as to effectively preventing the wireless pointer from missing when taken along.

To sum up, the present invention can effectively enhance the efficiency of use of the cursor controller of a notebook computer so as to enhance the sale of notebook computers and to increase the convenience of operation of notebook computers.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A notebook computer having a separable cursor controller through which the cursor of said notebook computer can be controlled, said notebook computer comprising
a shell body;
a wireless pointer having a rechargeable battery, a wireless transmission unit, a first displacement detecting unit, and a first interface circuit;
a wired pointer having a second displacement detecting unit and a second interface circuit;
an electric contact for acquiring external electricity to enable said wired pointer and to charge said rechargeable battery when said cursor controller is joined with said notebook computer, the displacement signal of said wired pointer being transferred to said notebook computer via said electric contact; and
a switching device capable of switching said rechargeable battery to provide electricity for said wireless pointer when said cursor controller is separated from said notebook computer so that said wireless pointer can transfer the displacement signal to control the cursor of said notebook computer in wireless way.

2. The notebook computer as claimed in claim 1, wherein said switching device cuts off the electric path of said rechargeable battery to said wireless pointer when said cursor controller is joined with said notebook computer so that said wired pointer of said cursor controller can control the cursor of said notebook computer via said electric contact.

3. The notebook computer as claimed in claim 1, wherein said shell body has a receiving space for receiving said cursor controller.

4. The notebook computer as claimed in claim 3, wherein said receiving space has a corresponding connector therein for achieving electric connection between said cursor controller and said notebook computer.
